(19) United States
(12) Patent Application Publication
(10) Pub. No.: US 2025/0376325 A1
(43) Pub. Date: Dec. 11, 2025

(54) METHOD AND APPARATUS FOR SCHEDULING LOADING BAGGAGE

(71) Applicant: Noblelogis Co., Ltd., Gyeonggi-do (KR)

(72) Inventor: Woojae Jeong, Gyeonggi-do (KR)

(21) Appl. No.: 19/226,870

(22) Filed: Jun. 3, 2025

(30) Foreign Application Priority Data
Jun. 5, 2024 (KR) 10-2024-0073894

(51) Int. Cl. B65G 1/04; B65G 1/137

(52) U.S. Cl. CPC B65G 1/0492; B65G 1/0478; B65G 1/1378

(57) ABSTRACT

According to one embodiment of the present disclosure relates to a method for scheduling baggage loading in a smart warehouse, performed by a smart warehouse terminal apparatus. The method includes determining a storage space in the smart warehouse for storing a baggage based on baggage status information of the baggage loaded onto a cargo vehicle upon completion of loading the baggage onto the cargo vehicle at a destination; calculating an estimated arrival time at which the cargo vehicle is expected to arrive at the smart warehouse based on traffic status information between the smart warehouse and the destination; and initiating a pre-setting process at a required point in time within the estimated arrival time to load the baggage from the cargo vehicle into the determined storage space in the smart warehouse.

### CROSS-REFERENCE TO RELATED PATENT APPLICATION

This application is based on and claims priority under 35 U.S.C. § 119(a) of a Korean Patent Application No. 10-2024-0073894, filed on Jun. 5, 2024, in the Korean Intellectual Property Office, the disclosure of which is incorporated by reference herein in its entirety.

### BACKGROUND OF THE INVENTION

### 1. Field of the Invention

Various embodiments of the present disclosure relate to a method and an apparatus for scheduling loading baggage, and more particularly, to a method and an apparatus for efficiently arranging baggage unloaded from a cargo vehicle into storage spaces of a smart warehouse.

### 2. Description of Related Art

In recent years, the number of people needing to store baggage for extended periods has been increasing due to reasons such as overseas business trips and home remodeling. There has also been a growing demand for short-term baggage storage in situations such as moving or house cleaning.

Accordingly, the necessity for short-term and long-term baggage storage is becoming more significant. To meet this need, baggage storage systems for temporarily or extendedly storing personal belongings are receiving increasing attention.

However, in such baggage storage systems, it is often difficult to predict the arrival time of incoming baggage, making it challenging to efficiently manage both newly arrived baggage and baggage that is already stored.

Accordingly, conventional warehouse operation methods had to rely primarily on static and predictable schedules. That is, typical warehouse managers could only allocate sufficient labor and resources after each cargo vehicle arrived, and then place the unloaded cargo into designated storage spaces through loading scheduling.

However, such baggage placement processes inevitably required significant time and made it difficult to respond to unexpected situations. For example, on certain days when storage spaces in the warehouse were already fully occupied, it was necessary to coordinate the placement of newly arriving baggage with previously stored baggage, which resulted in considerable delays.

In addition, in conventional systems, resources such as elevators used for moving baggage within the warehouse were statically assigned.

As a result, when sudden baggage handling was needed, the limited number of elevators prevented immediate processing of baggage that arrived unexpectedly.

Thus, due to such unpredictable circumstances, conventional warehouse operation methods faced difficulties in managing baggage loading schedules within the warehouse and had limitations in the efficient use of resources such as elevators.

Examples of the related art include Korean Registered Patent Publication No. 10-2056827 (Registration Date: Dec. 11, 2019) and Korean Registered Patent Publication No. 10-2187438 (Registration Date: Dec. 1, 2020).

### SUMMARY OF THE INVENTION

Various embodiments of the present disclosure are directed to providing a method and an apparatus for scheduling the loading of baggage, which identify suitable storage spaces in consideration of the loading state of baggage on a cargo vehicle and the movement paths within a smart warehouse, and complete pre-setting before baggage is actually placed.

According to one embodiment of the present disclosure relates to a method for scheduling baggage loading in a smart warehouse, performed by a smart warehouse terminal apparatus. The method includes determining a storage space in the smart warehouse for storing a baggage based on baggage status information of the baggage loaded onto a cargo vehicle upon completion of loading the baggage onto the cargo vehicle at a destination; calculating an estimated arrival time at which the cargo vehicle is expected to arrive at the smart warehouse based on traffic status information between the smart warehouse and the destination; and initiating a pre-setting process at a required point in time within the estimated arrival time to load the baggage from the cargo vehicle into the determined storage space in the smart warehouse.

In one embodiment, the smart warehouse may include a plurality of storage spaces arranged in a matrix structure, and at least one storage space corresponding to the amount of the baggage loaded on the cargo vehicle may be determined from among the plurality of storage spaces.

In one embodiment, the baggage status information includes at least one of a weight, volume, height, temperature, humidity, and smell of the baggage.

In one embodiment, if floor-to-floor transfer is required to move the loaded baggage to the determined storage space, a movement of an elevator may be included in the pre-setting process.

In one embodiment, the required point in time may be determined, in order to secure a baggage movement path to the determined storage space in the smart warehouse, based on time information required to move other baggage positioned along the baggage movement path.

In one embodiment, the method may further include assigning different cargo vehicles respectively to each of a plurality of destinations upon receiving requests for baggage transport from the plurality of destinations.

In one embodiment, the initiating of the pre-setting process may be characterized in that, based on the baggage status information of the baggage loaded at each of the respective destinations, storage spaces for respective baggage are determined, and when the estimated arrival times of the cargo vehicles carrying the respective baggage are calculated to fall within a certain time range, a baggage movement path is configured such that the storage space for the baggage loaded on the cargo vehicle expected to arrive first at the smart warehouse is set as a final destination and the storage space of baggage loaded on subsequently arriving cargo vehicles is set as waypoints.

In one embodiment, the initiating of the pre-setting process may be characterized in that when the number of destinations is three or more, a plurality of waypoints is set in the baggage movement path, and the storage space for the baggage expected to arrive earlier is arranged closer to the final destination along the baggage movement path, based on the estimated arrival times of the cargo vehicles carrying the respective baggage.

In one embodiment, the method may further include selecting a smart warehouse in which the baggage is to be stored among a plurality of smart warehouses, based on baggage status information of the baggage loaded in the cargo vehicle at the destination.

According to one embodiment of the present disclosure relates to a smart warehouse terminal apparatus for scheduling baggage loading in a smart warehouse. The smart warehouse terminal apparatus includes a memory configured to store at least one program instruction; and a processor, wherein the at least one program instruction, when executed by the processor, causes the processor to: determine a storage space in the smart warehouse for storing a baggage based on baggage status information of the baggage loaded onto a cargo vehicle upon completion of loading the baggage onto the cargo vehicle at a destination; calculate an estimated arrival time at which the cargo vehicle is expected to arrive at the smart warehouse based on traffic status information between the smart warehouse and the destination; and initiate a pre-setting process at a required point in time within the estimated arrival time to load the baggage from the cargo vehicle into the determined storage space in the smart warehouse.

As described above, various embodiments of the present disclosure provide the effect of enabling long-term and stable storage of baggage by determining optimal storage spaces based on baggage status.

In addition, by performing pre-setting that relocates other baggage located along the baggage movement route within the estimated arrival time, the baggage can be quickly placed into the determined storage space immediately upon the arrival of the cargo vehicle.

Furthermore, since elevator movement can also be pre-set, baggage can be quickly placed into the determined storage space even when multiple cargo vehicles arrive sequentially or simultaneously.

Moreover, by securing the optimal baggage movement route in advance, baggage can be quickly placed into the determined storage space even if multiple cargo vehicles arrive in rapid succession.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a diagram schematically illustrating a baggage loading scheduling system according to an embodiment of the present disclosure;

FIG. 2 is a diagram schematically illustrating a smart warehouse terminal apparatus of the baggage loading scheduling system according to an embodiment of the present disclosure;

FIG. 3 is a flowchart schematically illustrating a method for scheduling baggage loading according to an embodiment of the present disclosure;

FIG. 4 is a diagram schematically illustrating storage spaces, a baggage storage unit, and a baggage loading/unloading unit of a smart warehouse used in baggage loading scheduling according to an embodiment of the present disclosure;

FIG. 5 is a diagram schematically illustrating a front view of the configuration of the baggage storage unit according to an embodiment of the present disclosure;

FIG. 6 is a diagram illustrating a movement route among a plurality of storage spaces for transferring loaded baggage to a determined storage space according to an embodiment of the present disclosure;

FIG. 7 is a flowchart illustrating a method for scheduling baggage loading in a case where cargo vehicles are assigned to correspond to a plurality of destinations according to an embodiment of the present disclosure;

FIG. 8 is a diagram illustrating a baggage movement route set during the scheduling process of FIG. 7 according to an embodiment of the present disclosure;

FIG. 9 is a diagram schematically illustrating a smart warehouse terminal apparatus having a configuration different from that of FIG. 2 according to an embodiment of the present disclosure;

### DETAILED DESCRIPTION OF EMBODIMENTS

The embodiments described in this specification and the configurations illustrated in the drawings are merely exemplary of preferred examples of the disclosed invention. At the time of filing of the present application, various modifications that can replace the embodiments and drawings of this specification may exist.

Also, identical reference numerals or symbols presented in each drawing of this specification refer to components or elements that perform substantially the same function.

In addition, suffixes such as “-unit” used for components in the description of this specification are assigned or used interchangeably merely for ease of drafting and do not, by themselves, imply different meanings or functions. Expressions such as “A and/or B” and “at least one of A and B” may include all possible combinations of the listed items.

In this specification, terms such as “comprise” or “may comprise” are intended to specify the presence of stated features, numbers, steps, operations, elements, components, or combinations thereof, but do not preclude the presence or addition of one or more other features, numbers, steps, operations, elements, components, or combinations thereof.

The terminology used in this specification is intended to describe particular embodiments only and is not intended to limit the scope of other embodiments. Singular expressions may include plural forms unless the context clearly dictates otherwise. All terms, including technical and scientific terms, are to be interpreted as having the same meanings as those generally understood by one of ordinary skill in the art to which the present disclosure pertains. Terms that are not explicitly defined herein shall be interpreted as having meanings consistent with those found in commonly used dictionaries, in view of the relevant technical context, and shall not be interpreted in an overly idealized or overly formal sense unless explicitly defined otherwise in the present application. Even in cases where a term is defined in the present application, such definition shall not be construed to exclude embodiments of the present disclosure.

Hereinafter, preferred embodiments of the present disclosure will be described in more detail with reference to the accompanying drawings.

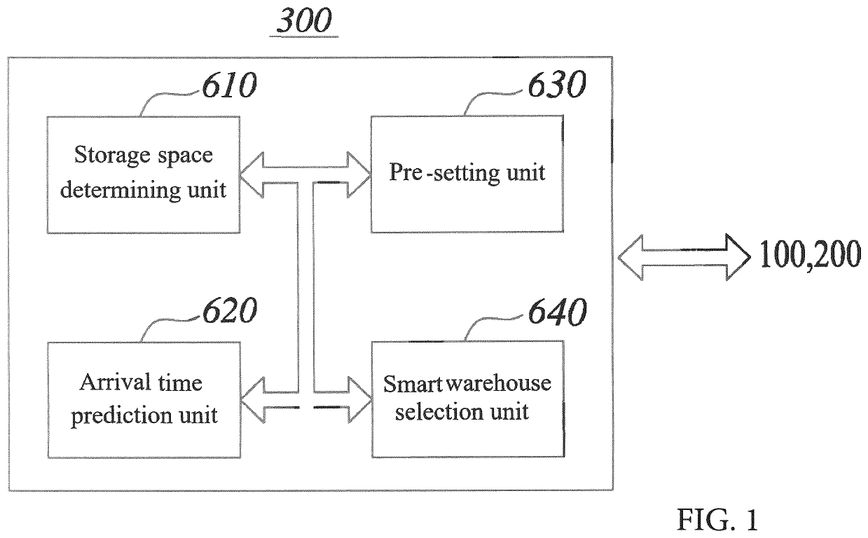

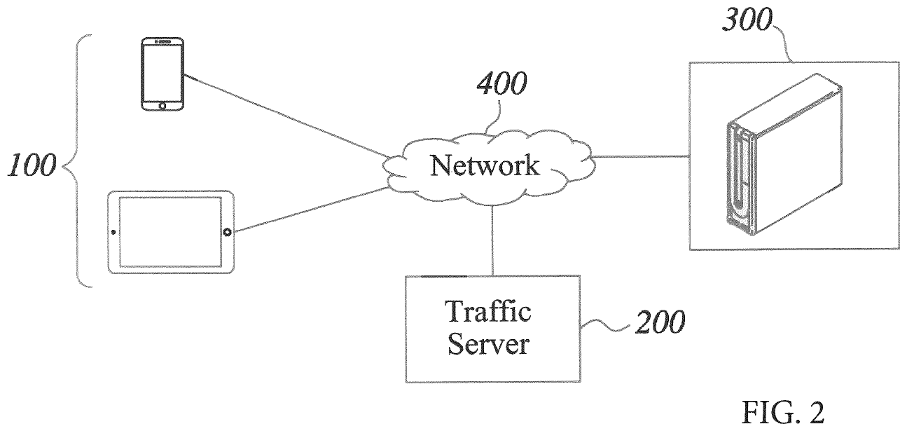

FIG. 1 is a diagram schematically illustrating a baggage loading scheduling system according to an embodiment of the present disclosure, and FIG. 2 is a diagram schematically illustrating a smart warehouse terminal apparatus of the baggage loading scheduling system according to an embodiment of the present disclosure. FIG. 2 will be referenced as a supplementary figure when explaining FIG. 1.

Referring to FIG. 1, a baggage loading scheduling system according to an embodiment of the present disclosure may include a cargo vehicle terminal (100), a traffic server (200), a smart warehouse terminal apparatus (300), and a network (400) including a wireless network.

In one embodiment, the cargo vehicle terminal (100) may be a terminal installed in each respective cargo vehicle and may be connected to the smart warehouse terminal apparatus (300) via the wireless network (400), thereby enabling the transmission and reception of various types of data between the cargo vehicle terminal (100) and the smart warehouse terminal apparatus (300).

For example, when loading of baggage onto the cargo vehicle is completed, the cargo vehicle terminal (100) may transmit a loading completion message, along with location information of the cargo vehicle located at the destination, to the corresponding smart warehouse terminal apparatus (300) via the wireless network (400).

In this case, the destination may refer to a location (position) where the baggage (goods) requested by a user is located, or where baggage to be loaded from another arbitrary smart warehouse or from another logistics warehouse is located. On the other hand, location information of the cargo vehicle can generally be acquired through widely known GPS.

In addition, the cargo vehicle terminal (100) may generate baggage status information by identifying the status of baggage loaded at each destination, or may generate the baggage status information by measuring the status of the baggage loaded in the vehicle using specific sensors. If the baggage status information is generated, it may be further transmitted to the corresponding smart warehouse terminal apparatus (300) via the wireless network (400).

The generated baggage status information may include at least one of weight, quantity, height, temperature, humidity, and odor of the baggage, but is not necessarily limited thereto. Accordingly, specific sensors may correspond to each type of the baggage status information.

The cargo vehicle terminal (100) is preferably a smartphone capable of wireless communication via LTE/4G/5G (e.g., iOS, Android, Windows Phone, etc.), but is not necessarily limited thereto. Such a smartphone may include an LTE/4G/5G modem, GPS receiver, wireless communication module, and an in-vehicle IoT device.

Meanwhile, the cargo vehicle terminal (100) and the smart warehouse terminal apparatus (300), which will be described later, may be connected via the wireless network (400). The wireless network (400) may include at least one of LTE (Long-Term Evolution), LTE-A (LTE Advanced), CDMA (Code Division Multiple Access), WCDMA (Wideband CDMA), UMTS (Universal Mobile Telecommunications System), WiBro (Wireless Broadband), WiFi (Wireless Fidelity), Bluetooth, NFC (Near Field Communication), and GNSS (Global Navigation Satellite System).

In one embodiment, the traffic server (200) may acquire vehicle information using cameras installed on roads throughout the country, and may also acquire traffic accident information from reported incidents. Based on the acquired information, the traffic server (200) may generate traffic status information as statistical data, including road conditions, traffic congestion, and traffic accidents. The generated traffic status information may be transmitted to the smart warehouse terminal apparatus (300) via the network (400).

In this case, the network (400) may be a wireless network or a wired network. The wireless network may include at least one of LTE (Long-Term Evolution), LTE-A (LTE Advanced), CDMA (Code Division Multiple Access), WCDMA (Wideband CDMA), UMTS (Universal Mobile Telecommunications System), WiBro (Wireless Broadband), WiFi (Wireless Fidelity), Bluetooth, NFC (Near Field Communication), and GNSS (Global Navigation Satellite System).

On the other hand, when the network (400) is a wired network, the wired network may include at least one of USB (Universal Serial Bus), HDMI (High Definition Multimedia Interface), RS-232 (Recommended Standard), LAN (Local Area Network), WAN (Wide Area Network), the Internet, and the telephone network. However, the types of such network (400) are not necessarily limited thereto.

The traffic server (200) may be at least one of a traffic information provider server, a traffic control center server, a predictive analytics server, or a government agency server. The traffic information provider server may collect real-time traffic information through a traffic information provider and provide related services, and such services may generate traffic status information based on real-time data such as road conditions, traffic congestion, accidents, and construction.

On the other hand, the traffic control center server is operated by a traffic control center that monitors and manages traffic in a city or region. It may generate traffic status information by monitoring necessary road conditions using traffic cameras, sensors, vehicle tracking systems, and the like. The predictive analytics server may predict traffic conditions based on historical data and real-time traffic data, and may generate traffic status information by analyzing and forecasting traffic patterns in each area or road using big data and machine learning technologies.

In one embodiment, the smart warehouse terminal apparatus (300) may be a terminal installed for each smart warehouse and may be connected to the cargo vehicle terminal (100) installed in each cargo vehicle via the wireless network (400), and may also be connected to the traffic server (200) via a wired or wireless network (400).

The smart warehouse terminal apparatus (300) may include a communication interface (310), a memory (320), and a processor (330), as illustrated in FIGS. 1 and 2.

In one embodiment, the communication interface (310) may support a communication interface suitable for the form of the network (400). For example, if the network (400) is a wireless network, the interface suitable for a wireless connection may be provided; and if the network (400) is a wired network, the interface suitable for a wired connection may be provided.

In one embodiment, the memory (320) may serve as a storage medium capable of temporarily or partially permanently storing at least one instruction. For example, in order to temporarily or partially permanently store data processed by the processor (330) described below, it may include at least one of RAM (DRAM, SRAM), cache memory, flash memory, and virtual memory, but is not necessarily limited thereto.

In one embodiment, the processor (330) may execute at least one instruction stored in the memory (320) when the instruction related to various types of functional operations is stored therein.

Through this, the processor (330) may, in principle, acquire or input various types of information, including: information on multiple cargo vehicles; phone number information of the cargo vehicle terminals (100) installed in the respective cargo vehicles; driver information of the owners of the cargo vehicle terminals (100); vehicle registration numbers; and vehicle identification numbers (VINs), from each cargo vehicle terminal (100), and may thereby pre-register and store the information in the memory, so as to manage each affiliated cargo vehicle terminal (100).

Additionally, the processor (330), according to an embodiment, may also manage the storage status of the smart warehouse. For example, it may manage information about a plurality of storage spaces installed in the smart warehouse, the storage containers placed within those spaces, and the baggage information stored in the containers.

Once this basic management is established, the processor (330) is also connected to the cargo vehicle terminal (100) via the wireless network (400) and the communication interface (310), and may transmit and receive data between the cargo vehicle terminals (100).

For example, the processor (330) may receive vehicle location information, baggage status information, and a baggage loading completion message generated after the baggage is loaded at the destination from the corresponding cargo vehicle terminal (100) via the wireless network (400) and the communication interface (310).

The received vehicle location information may be collected in real time, and the collected location may also be displayed in real time on a map.

Furthermore, after receiving the baggage loading completion message from the cargo vehicle terminal (100) via the wireless network (400) and the communication interface (310), the processor (330) may determine the storage space for the baggage based on the baggage status information received from the cargo vehicle terminal (100).

For example, assuming that the baggage status information indicates that the baggage is sensitive to humidity, the smart warehouse terminal apparatus (300) may determine a storage space suitable for long-term storage of humidity-sensitive baggage as the location for placing the baggage.

The determined storage space may be a location with low humidity that reflects the humidity sensitivity of the baggage, a space with good ventilation, or a space equipped with a humidity sensor for humidity control.

Furthermore, the processor (330) may calculate an estimated arrival time required for the cargo vehicle to arrive at the managed smart warehouse based on traffic conditions and travel distance along the expected route between the smart warehouse and the destination.

The calculated estimated arrival time may be used to perform pre-setting in order to move the baggage loaded from the cargo vehicle arriving at the smart warehouse entrance into the determined storage space.

That is, the processor (330) according to an embodiment may secure a baggage movement path for baggage loaded from the cargo vehicle arriving at the smart warehouse entrance, and perform pre-setting to move at least one piece of other baggage located in other storage spaces on the secured baggage movement path within the estimated arrival time.

Here, the baggage movement path may refer to a path secured for unobstructed cargo movement, in which, when a cargo vehicle arrives at the elevator entrance and unloads the cargo, any baggage carrier already positioned along the route to the determined storage space, either obstructing movement or occupying the determined storage space, is relocated to another storage location to clear the way.

Hereinafter, a detailed description will be given of a baggage loading scheduling method performed by the processor 330 of the smart warehouse terminal apparatus 300.

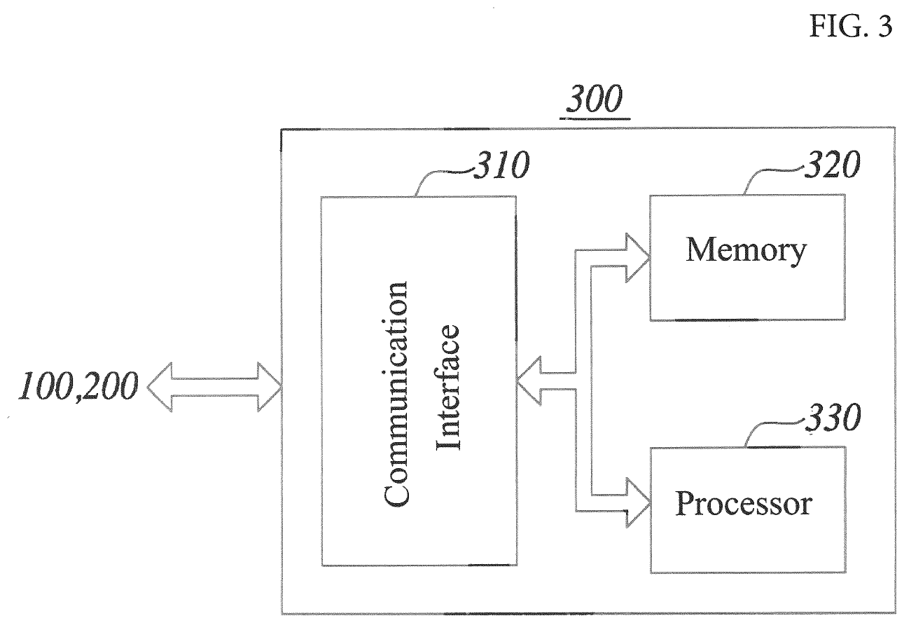

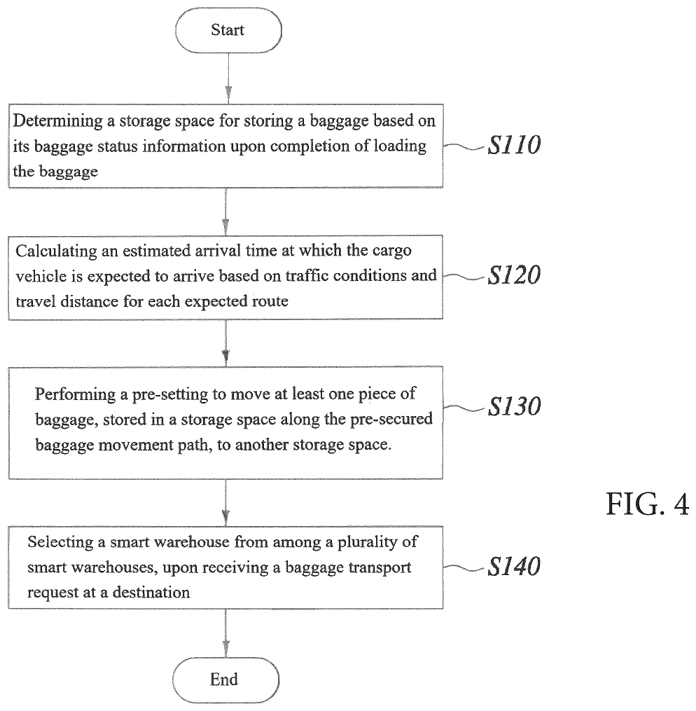

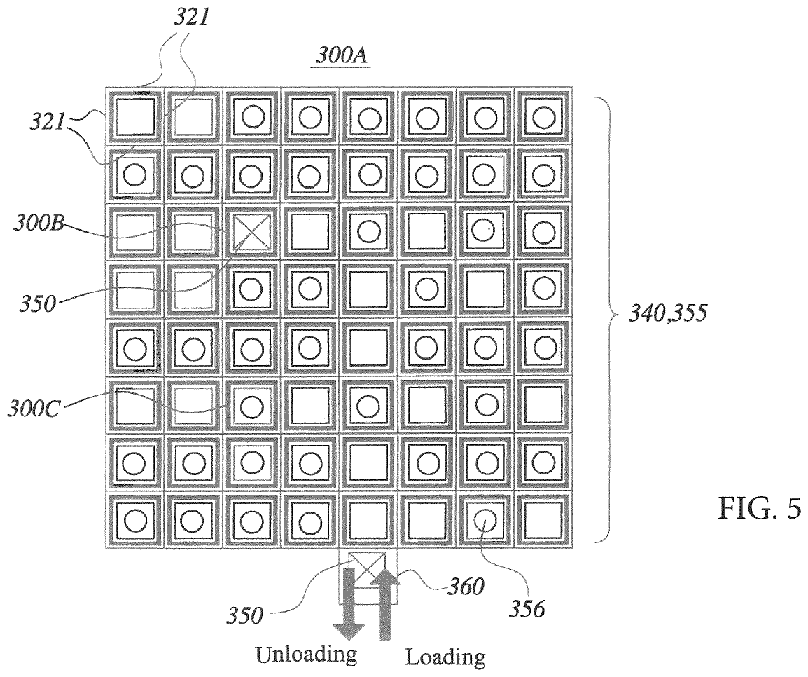

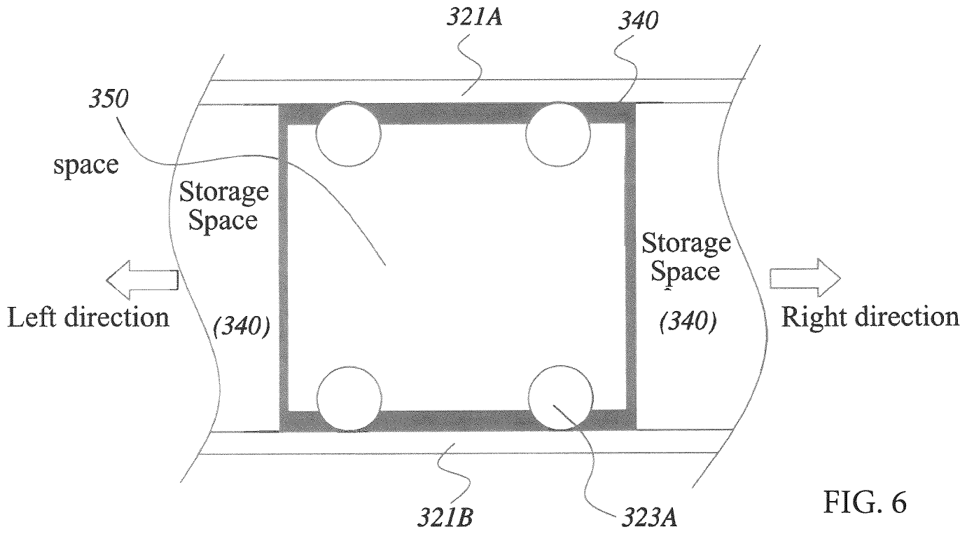

FIG. 3 is a flowchart illustrating, by way of example, a baggage loading scheduling method according to an embodiment of the present disclosure, FIG. 4 is a diagram schematically illustrating a storage space, a baggage storage unit, and a baggage loading/unloading unit of a smart warehouse used in the baggage loading scheduling method according to an embodiment of the present disclosure, FIG. 5 is a front view diagram schematically illustrating a configuration of the baggage storage unit according to an embodiment of the present disclosure, and FIG. 6 is a diagram illustrating a movement path among multiple storage spaces for transferring the loaded baggage to the determined storage space according to an embodiment of the present disclosure.

FIGS. 4 to 6 will be referenced as supplementary illustrations when explaining FIG. 3.

Referring to FIG. 3, a baggage loading scheduling method according to an embodiment may include steps S110 to S140, which are performed by the processor 330 of the smart warehouse terminal apparatus 300 in order to schedule the baggage to be stored in the smart warehouse.

In step S110, the processor 330 may receive, via the wireless network 400, a notification from the cargo vehicle terminal 100 indicating that baggage transport from a destination has been requested. After this reception, the processor may further receive a baggage loading completion message from the cargo vehicle terminal 100 via the wireless network 400. Based on the received completion message, the processor can confirm that the baggage has been loaded onto the vehicle.

Furthermore, the processor (330) may receive baggage status information loaded onto the cargo vehicle from the cargo vehicle terminal (100) via the wireless network (400). The received baggage status information may include at least one of the weight, quantity, height, temperature, humidity, and odor of the baggage, but is not limited thereto.

Here, the baggage status information related to the weight, quantity, height, temperature, humidity, and odor of the baggage may be information entered by the driver according to the characteristics of each piece of baggage loaded onto the cargo vehicle, or may reflect user requests related to the weight, quantity, height, temperature, humidity, and odor. This information may also be practically entered by the driver.

However, the information is not limited to that, and each baggage status information may also be acquired using sensors installed in the cargo vehicle.

For example, a load sensor may detect the pressure generated when baggage is loaded onto the vehicle to acquire the weight status, and a volume or ultrasonic sensor may calculate the occupied space of the loaded baggage to acquire the quantity (volume) of the baggage.

Additionally, for example, a height sensor or ultrasonic sensor may measure the height by detecting signals emitted from the top of the loaded baggage in the cargo vehicle to acquire the baggage's height status. A temperature sensor may measure the temperature of the baggage loaded in the cargo vehicle to acquire its temperature status, and a humidity sensor may measure the surrounding humidity to acquire the baggage's humidity status.

Furthermore, for example, an odor sensor may measure the odor of the baggage loaded in the cargo vehicle to acquire its odor status. The odor sensor may be any one of a gas sensor, volatile organic compound (VOC) sensor, or catalytic odor sensor, but is not necessarily limited thereto.

Accordingly, the processor (330) may determine a storage space among the plurality of storage spaces in the smart warehouse where the baggage will be stored, based on the baggage status information received from the cargo vehicle terminal (100). In this case, the determined storage spaces may be multiple locations such that the baggage is distributed and arranged.

For example, as shown in FIG. 4, if the smart warehouse (300A) includes a plurality of storage spaces (340) partitioned in a grid structure, the processor (330) may determine at least one storage space (300B) corresponding to the volume status of the baggage loaded in the cargo vehicle from among the plurality of grid-structured storage spaces (340). That is, if the volume of the baggage is large, the processor may determine at least one storage space (300B) that matches the volume, and the baggage may be stored in the interior of the respective storage spaces.

Here, the grid structure corresponds to a matrix structure. For example, as shown in FIG. 4, if the structure is an 8×8 matrix, 64 storage spaces (340) may be arranged in a grid format. If other baggage is already placed in the determined storage space (300B), it may be moved to a different storage space, and the newly loaded baggage may be placed into the now-empty storage space.

Here, it is not the baggage itself that is physically moved to the storage space, but rather the baggage is loaded onto a baggage container (350) provided in the baggage loading/unloading unit (360) of the elevator. Under the control of the processor (330), the loaded baggage container (350) is moved to the determined storage space (300B) among the plurality of storage spaces (340), thereby effectively placing the baggage into the designated storage space.

Accordingly, the baggage container (350) shown in FIG. 4 may be positioned at the baggage loading/unloading unit (360), and after loading the baggage that has been unloaded from the cargo vehicle, it may be moved under the control of the processor (330) to the designated storage space (300B) among the plurality of storage spaces (340).

Although only the upper portion of the grid-structured rail (321) is illustrated in FIG. 4, FIG. 5 may additionally show rails formed in the same grid structure (321) both on the upper (321A) and lower (321B) sides.

Furthermore, as shown in FIG. 5, the baggage containers (350) may be placed into their designated storage spaces (300B) after being moved there while loaded with baggage. When there are no obstacles along the upper and lower rails (321), the multiple baggage containers (350) can move back and forth as well as side to side. In this case, the baggage container (350) is a shelf (rack) capable of holding baggage, and includes wheels (e.g., rollers) that contact the upper and lower rails (321A, 321B). Only the baggage container (350) carrying the baggage can be placed in the corresponding storage space (340).

For example, when there are 64 partitioned storage spaces (340), in theory, baggage containers (350) could be placed into each of the 64 storage spaces. However, in practice, the baggage containers (355) are not arranged across all 64 partitioned storage spaces (340) along the upper and lower grid rails (321).

The reason is that the already-placed baggage containers (356) cannot be moved into vacant spaces, and thus all 64 baggage containers (355) cannot be simultaneously received and placed.

With such a structure of multiple storage spaces (340) and baggage containers (350, 355) in the smart warehouse, in step S110, the processor (330) may determine a storage space (300C) corresponding to a temperature condition among the grid-structured storage spaces (340), when the received baggage status information pertains to temperature.

For example, if the baggage to be placed in the determined storage space is a temperature-sensitive item, the processor (330) may determine a storage space (300C) that corresponds to the measured temperature condition of the item, and the baggage container (350) carrying the baggage can be moved and placed into the determined storage space (300C).

Additionally, in step S110, the processor (330) may determine respective storage spaces (not shown) that correspond to baggage status information such as weight, height, humidity, and smell. For instance, if the baggage weighs 100 kg, the processor (330) may determine a storage space among the plurality of storage spaces (340) that can support 100 kg. Similarly, if the height of the baggage is 50 cm, the processor (330) may determine a storage space that is larger than 50 cm in height.

Additionally, when the baggage status information pertains to humidity, the processor (330) may determine a storage space among the plurality of storage spaces (340) that corresponds to the humidity condition. For example, such a storage space may be one located in a well-ventilated area, an area equipped with a dehumidifier, an area with low humidity, or one with good air circulation.

Returning to FIG. 3, in step S120, the processor (330) may calculate an estimated arrival time required for the cargo vehicle to arrive at the smart warehouse, based on the traffic conditions and travel distance for each expected route between the smart warehouse and the destination.

More specifically, the processor (330) may identify the expected route and travel distance between the destination cargo vehicle and the smart warehouse based on real-time location information obtained from the cargo vehicle terminal (100), and may map traffic status information acquired from the traffic server (200) onto the expected route. Accordingly, the processor (330) may calculate the estimated arrival time required for the cargo vehicle to reach the smart warehouse based on the traffic conditions and travel distance along the expected route.

The obtained real-time location information, expected route, travel distance, and estimated arrival time may be visualized on a location-based 3D map.

However, the present disclosure is not limited thereto. In step S120, the processor (330) may calculate the travel distance between the current location of the in-transit cargo vehicle and the coordinates of the smart warehouse, and may acquire real-time traffic information from the traffic server (200) to determine the current traffic conditions along the route. The processor (330) may also compute the final estimated arrival time by adjusting the estimated travel time based on the collected real-time traffic data, such as traffic congestion, accidents, road construction, and weather conditions, in conjunction with the travel distance.

In this case, the estimated travel time may be calculated based on the average travel speed of vehicles under normal road conditions. Accordingly, the final estimated arrival time may be calculated based on traffic congestion, accidents, road construction, weather conditions, the average vehicle speed, and the travel distance.

In step S130, as illustrated in FIGS. 3 and 6, prior to the arrival of the cargo vehicle at the entrance of the smart warehouse, that is, within the estimated arrival time, the processor (330) may secure a baggage movement path (370) among the plurality of storage spaces (340) for the baggage to be unloaded from the cargo vehicle. To do so, the processor may move at least one piece of baggage stored in a storage space (375) along the baggage movement path (370) to another storage space. This process of securing the baggage movement path in advance is referred to as a “pre-setting.”

For example, as illustrated in FIG. 6, if the estimated arrival time is 100 minutes, then before placing the baggage unloaded from the cargo vehicle into the determined storage space (380) and the loading/unloading unit (360), the processor (330) may move at least one baggage container (345), which is already placed in a storage space (375) located along the baggage movement path (370) between the loading/unloading unit (360) and the determined storage space (380), to another storage space (385) so that there are no obstacles (e.g., a baggage container marked with “X”) in the path. The other storage space (385) may be located at various positions within the smart warehouse.

Here, although it is actually the baggage container (350) carrying the baggage that is moved to the other storage space (385), it is expressed for convenience as the baggage itself being moved.

In the case where floor-to-floor transfer is required to load the baggage into the determined storage space, the elevator movement may also be included in the aforementioned pre-setting. That is, in step S130, the processor (330) may pre-set elevator movement in advance, for example, when the determined storage space (380) is located on a floor other than the first floor.

By pre-setting the elevator movement as described above, the baggage arriving around the estimated arrival time can be immediately unloaded from the cargo vehicle, loaded directly into a baggage container equipped in the elevator, and transported to the determined storage space.

Meanwhile, in step S130, the processor (330) may determine the start time of the pre-setting based on the time required to move the other baggage for securing the baggage movement path.

In this case, the start time of the pre-setting refers to the required point in time when the necessary operations begin before the baggage movement starts, and it means completing all the preparations in advance so that the baggage can be moved smoothly by the target time.

For example, in order to move a certain baggage, it may be necessary to first move another baggage with a higher priority. Based on time information, the processor (330) can calculate when to begin moving the other baggage in advance, thereby allowing sufficient time to relocate the baggage container (baggage) acting as an obstacle on the baggage movement path to another storage space before the target time (indicated by the time information).

In step S140, while managing baggage storage across storage spaces of multiple smart warehouses, when baggage loading is completed at the destination and the request of baggage transport is received from the cargo vehicle terminal (100) mounted on the cargo vehicle, the processor (330) may select one of the smart warehouses to store the baggage.

In this case, the processor (330) may select a specialized smart warehouse among the plurality of smart warehouses that matches the nature of the baggage loaded in the cargo vehicle.

Each of the plurality of smart warehouses may be designated to store specific types of baggage. For example, one smart warehouse may be designated for storing humidity-sensitive baggage, and another may be for temperature-sensitive baggage. Accordingly, the selected smart warehouse may be one of these specialized warehouses.

In such a case, the processor (330) may select a specialized smart warehouse that corresponds to the nature of the baggage, for example, based on baggage status information acquired from the cargo vehicle terminal (100).

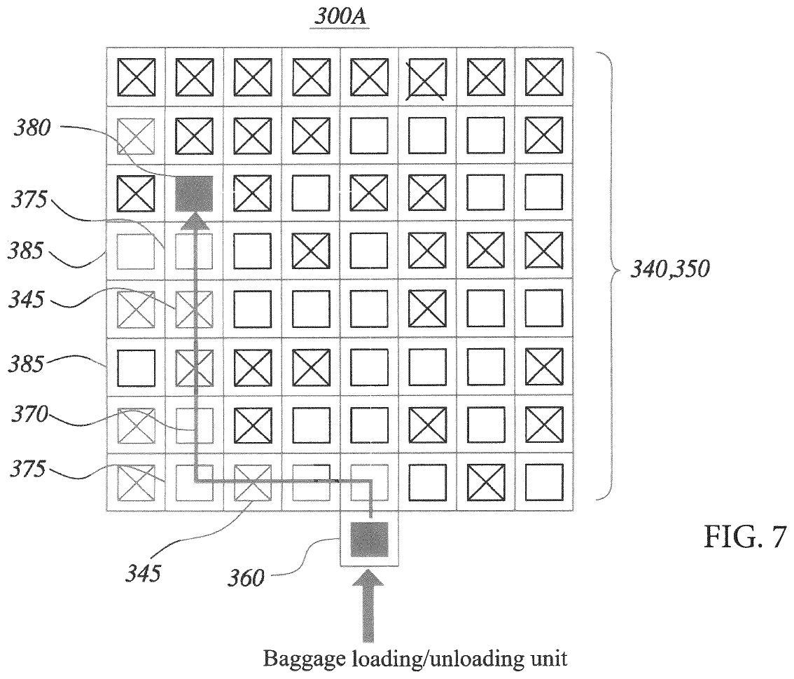

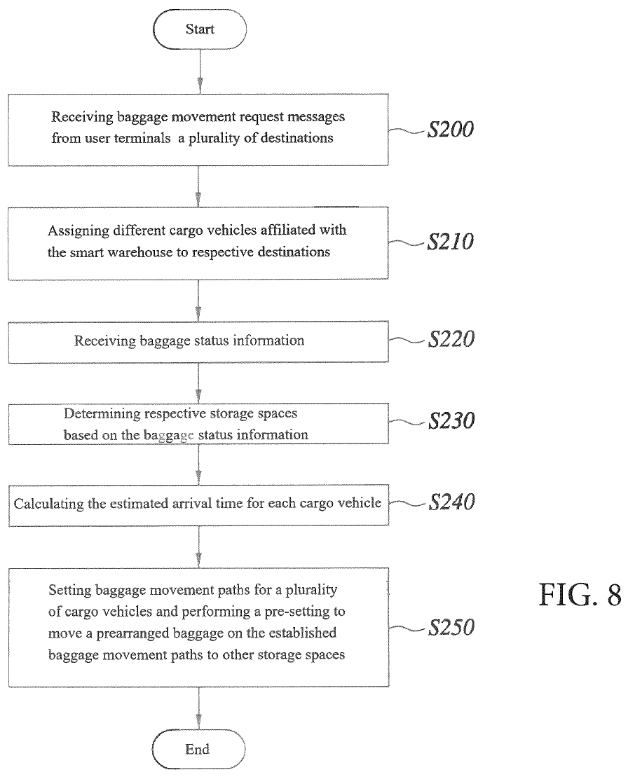

FIG. 7 is a flowchart illustrating an exemplary method for scheduling baggage loading in a case where cargo vehicles are dispatched to a plurality of destinations according to an embodiment of the present disclosure, and FIG. 8 is a diagram illustrating an example of setting a baggage movement path during the scheduling process of FIG. 7. FIG. 7 will be additionally referenced in the description of FIG. 6.

Referring to FIG. 7, the baggage loading scheduling method according to an embodiment of the present disclosure may include steps S200 to S250, performed by the processor (330) of the smart warehouse terminal apparatus (300), to efficiently schedule baggage in a case where cargo vehicles are assigned and dispatched to a plurality of destinations.

In step S200, the processor (330) may receive baggage transport request messages from a plurality of user terminals (not shown) located at the respective destinations. Here, the user terminal may be a personal terminal in the case of personal baggage, a terminal of a distribution logistics center in the case of manufactured products, or a terminal of a logistics center in the case of parcel delivery items.

The received baggage transport request message may include information such as destination address, personal information of the requester, type of baggage, and quantity of baggage, but is not limited thereto.

In step S210, upon receiving the baggage transport request message from a user terminal, the processor (330) may assign different cargo vehicles affiliated with a smart warehouse to the respective destinations.

To this end, the processor (330) may register and manage information of a given smart warehouse and a plurality of cargo vehicle information mapped to the smart warehouse information in advance. When baggage transport request messages are received from a plurality of destinations, the processor may select different cargo vehicles among the managed vehicles and assign them respectively to the destinations by issuing dispatch instructions.

In step S220, when each dispatched cargo vehicle loads its corresponding baggage, the processor (330) may receive baggage status information from the respective cargo vehicle terminals (100) installed in the vehicles via the network (400).

In step S230, the processor (330) may determine storage spaces for each baggage among the plurality of storage areas, based on the received baggage status information. Since the storage space determination method has been sufficiently explained with reference to FIGS. 3 to 6, a detailed explanation will be omitted here. However, unlike the cases described in FIGS. 3 to 6 which involve determining a storage space for a single piece of baggage, in FIG. 7, storage spaces are determined for multiple pieces of baggage individually, which marks a key difference in application.

In step S240, the processor (330) may calculate the estimated arrival time required for each cargo vehicle to reach the smart warehouse based on the traffic conditions and travel distance of the expected routes between the smart warehouse and each destination.

As the estimated arrival time is derived in the same manner as described in FIGS. 3 to 6, a detailed explanation will be omitted. However, while the estimated arrival time in FIGS. 3 to 6 refers to the arrival of a single vehicle, the estimated arrival time in FIG. 7 refers to the arrival times of multiple cargo vehicles to a single smart warehouse, which marks a distinction in application.

At this point, the processor (330) may determine whether the estimated arrival times of the cargo vehicles are within a predefined time range. For example, if the estimated arrival time of cargo vehicle A is calculated as 100 minutes, vehicle B as 90 minutes, and vehicle C as 80 minutes, then the time interval among them, which is maximum 20 minutes, may be regarded as within the predefined range.

Limiting the predefined time range to a very short interval allows the system to efficiently relocate obstructing baggage storage units from the baggage movement path and swiftly place multiple pieces of baggage into their designated storage spaces without confusion.

However, if the time intervals among the estimated arrival times of vehicles A, B, and C are relatively long, such cases may be regarded as having sufficient time to place each baggage item into its respective storage space, and thus may not fall within the predefined time range.

In step S250, the processor (330) may perform a pre-setting operation to secure the baggage movement path for loading baggage from each of the plurality of cargo vehicles within their respective estimated arrival times. This may involve relocating the baggage already stored in at least one storage space along the movement path to another storage space.

Since such pre-setting was already described in detail in FIGS. 3 to 6, a redundant explanation is omitted. However, unlike FIGS. 3 to 6 which pertain to a single baggage, the movement paths in this context are plural, as they relate to each individual piece of baggage.

In setting up a plurality of baggage movement paths, the processor (330), upon determining in step S240 that the estimated arrival times of cargo vehicles are within a certain time range, may establish a movement path (390) as illustrated in FIG. 8. In this case, the point of origin (391) may be set as a loading area near the entrance/exit unit (360) of the smart warehouse, the destination (392) may be the storage space allocated to the baggage loaded in the vehicle predicted to arrive first, and an intermediate stop (393) may correspond to the storage space for baggage in a vehicle arriving later.

For instance, when the baggage loaded in vehicle C, which has an estimated arrival time of 80 minutes, is scheduled to be placed in a designated storage space (392), the processor (330) may determine that space (392) as the destination. If the baggage in vehicle B, arriving after C, is scheduled to be placed in another designated storage space (393), the processor may designate that space (393) as an intermediate stop on the movement path.

As described above, the reason for designating the storage space of the baggage loaded in the cargo vehicle that is expected to arrive first at the smart warehouse as the destination (392), and the storage space of the baggage loaded in the subsequently arriving vehicle as the intermediate stop (393), is to allow the processor (330) to relocate, in advance and in a single operation, the baggage storage units (347) located along the baggage movement path to other storage spaces. By securing a route in advance without obstacles (e.g., baggage storage units (347) pre-positioned along the route and marked as X), repetitive relocations of obstructing storage units can be avoided, thereby reducing the time required for such relocations and ultimately minimizing the time required for pre-setting.

In addition, in step S250, when there are three or more destinations and three cargo vehicles are used to load baggage from the respective destinations, the processor (330) may establish a single baggage movement path for the three pieces of baggage.

In this case, as shown in FIG. 8, the processor (330) may set multiple intermediate stops in the baggage movement path. For instance, based on the estimated arrival times of the cargo vehicles, the processor may designate a given storage space (392) as the destination (392) for the baggage in vehicle C, which is expected to arrive first. Then, it may designate the storage space (393) for the baggage in vehicle B, which is expected to arrive second, as adjacent to the destination (392) along the path. Lastly, the storage space (394) for the baggage expected to arrive third, and latest, may be set as an intermediate stop (394) located adjacent to the origin (391) along the movement path.

As such, when multiple intermediate stops are set between the origin and the destination for multiple pieces of baggage, and a single baggage movement path including the origin, multiple intermediate stops, and the destination is secured, the baggage storage units located between the origin and the destination can be relocated in advance and in a single operation. Consequently, even if a cargo vehicle arrives earlier than expected, the previously secured baggage movement path allows immediate initiation of the placement of each piece of baggage.

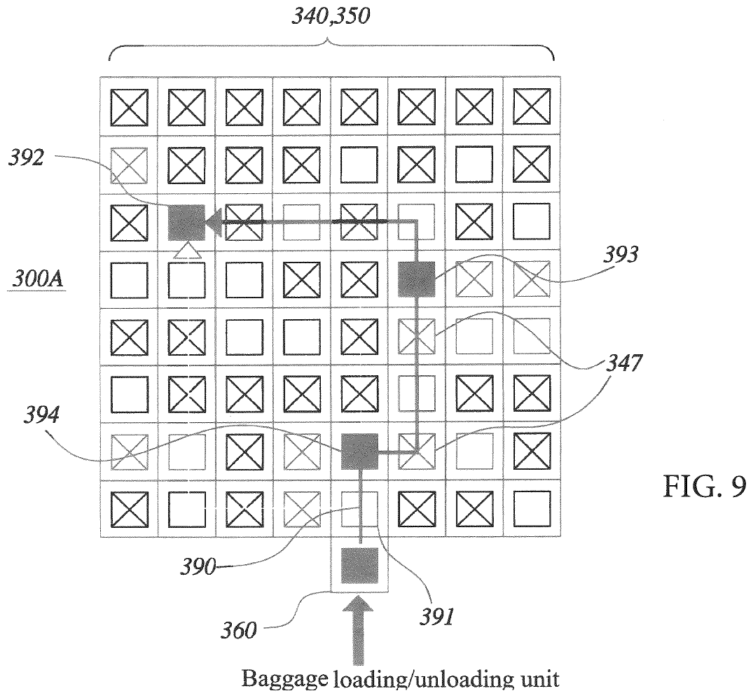

FIG. 9 is a diagram illustrating a different configuration of the smart warehouse terminal apparatus compared to that shown in FIG. 2, according to an embodiment of the present disclosure. At this time, the above-mentioned FIGS. 4 and 8 will be referenced as supplementary illustrations.

Referring to FIG. 9, the smart warehouse terminal apparatus 300 according to an embodiment of the present disclosure may include a storage space determining unit 610, an arrival time prediction unit 620, a pre-setting unit 630, and a smart warehouse selecting unit 640.

In one embodiment, the storage space determining unit 610 may receive, via the wireless network 400, a baggage transport request from the destination through the cargo vehicle terminal 100. After this reception, if a baggage completion message is further received from the cargo vehicle terminal 100 via the wireless network 400, it may be confirmed through the received baggage completion message that the loading operation onto the cargo vehicle has been completed.

Furthermore, the storage space determining unit 610 may receive, via the wireless network 400, baggage status information about the baggage loaded in the cargo vehicle from the cargo vehicle terminal 100. In this case, the received baggage status information may include at least one of the weight, volume, height, temperature, humidity, and odor of the baggage, but is not necessarily limited thereto.

Here, the baggage status information related to the weight, volume, height, temperature, humidity, and odor of the baggage may be information input by the driver in accordance with the characteristics of each piece of baggage to be loaded onto the cargo vehicle. Alternatively, the baggage status information may correspond to user requirements related to the weight, volume, height, temperature, humidity, and odor of the baggage, and in such cases, the information may also be practically input by the driver.

However, the information is not limited to this method, and each piece of baggage status information may also be obtained using various sensors installed on the cargo vehicle.

For example, a load sensor may detect the pressure generated when the baggage is loaded onto the vehicle to obtain the weight status of the baggage. A volume sensor or an ultrasonic sensor may calculate the volume occupied by the baggage when loaded onto the vehicle to obtain the volume (bulk) status of the baggage.

In addition, for example, a height sensor or an ultrasonic sensor may measure the height of the baggage by emitting a signal from the top of the loaded baggage, thereby obtaining the height status. A temperature sensor may measure the temperature of the loaded baggage to obtain its temperature status, and a humidity sensor may measure the surrounding humidity of the loaded baggage to obtain its humidity status.

Furthermore, for example, an odor sensor may detect the smell of the loaded baggage to obtain its odor status. This odor sensor may be any one of a gas sensor, a volatile organic compound (VOC) sensor, or a catalytic odor sensor, but is not necessarily limited thereto.

Accordingly, the storage space determining unit (610) may determine a storage space within the smart warehouse, among the plurality of available storage spaces, in which the baggage will be stored, based on the baggage status information received from the cargo vehicle terminal (100). In this case, the determined storage space may include a plurality of storage spaces in which the baggage is distributed and placed.

For example, as illustrated in FIG. 4, if the smart warehouse is composed of a plurality of storage spaces (340) partitioned in a grid structure, the storage space determining unit (610) may determine at least one storage space, among the plurality of grid-structured storage spaces (340), corresponding to the volume status of the baggage loaded onto the cargo vehicle. That is, if the volume of the baggage is large, the unit may determine at least one storage space that matches the size, and the baggage may be stored individually within those storage spaces.

Here, the grid structure is essentially the same as a matrix structure. For example, as shown in FIG. 4, in the case of an 8×8 matrix structure, 64 storage spaces (340) may be arranged in a grid format. If other baggage is already placed in the determined storage space, such baggage may be moved to other storage spaces before placing the newly loaded baggage into the determined storage space.

Here, in practice, the baggage itself is not directly moved into the storage space. Instead, the baggage is loaded onto a baggage holder (350) provided in the elevator, and under the control of the processor (330), the loaded baggage holder (350) is moved to the determined storage space among the plurality of storage spaces (340), thereby effectively placing the baggage into the designated storage space.

Accordingly, the baggage holder (350) illustrated in FIG. 4 may be placed at the location of the baggage loading/unloading unit (360), and after loading baggage unloaded from the cargo vehicle, it may be moved to the designated storage space among the plurality of storage spaces (340) under the control of the processor (330).

With the structure of the smart warehouse having a plurality of storage spaces (340) and baggage holders (350) as described, the storage space determining unit (610) may determine a storage space corresponding to the temperature status when the baggage status information pertains to temperature.

For example, if the baggage to be placed in the determined storage space is an item that is highly sensitive to temperature, the storage space determining unit (610) may determine a storage space corresponding to the measured temperature status of the item, and move the baggage holder (350) loaded with the corresponding baggage into the determined storage space.

Additionally, the storage space determining unit (610) may also determine respective storage spaces corresponding to the baggage status related to weight, height, humidity, and odor. For example, if the weight of the baggage is 100 kg, the storage space determining unit (610) may determine a storage space among the plurality of storage spaces (340) that can support 100 kg. Similarly, if the height of the baggage is 50 cm, the processor (330) may determine a storage space among the plurality of storage spaces (340) that can accommodate baggage taller than 50 cm.

In addition, when the baggage status information pertains to humidity, the storage space determining unit (610) may determine a storage space corresponding to the humidity status among the plurality of storage spaces (340). For example, such storage spaces may include locations with good ventilation, areas equipped with dehumidifiers, locations with naturally low humidity, or spaces with excellent air circulation functionality.

Furthermore, the storage space determining unit (610) according to an embodiment may receive a baggage transport request message from a user terminal (not shown) located at one of a plurality of destinations via the network (400). The user terminal may be a personal device in the case of personal baggage, or a terminal of a logistics distribution center in the case of manufactured goods or courier items.

The aforementioned baggage transport request message may include information such as the destination address, sender's personal information, type of baggage, and quantity of baggage, but is not necessarily limited to these.

Accordingly, when the storage space determining unit (610) receives the baggage transport request message from the user terminal, it may assign different cargo vehicles belonging to a smart warehouse to each of the received destinations.

To achieve this, the storage space determining unit (610) may have pre-registered and managed information on one or more smart warehouses and the plurality of cargo vehicles mapped to each warehouse. Upon receiving baggage transport request messages from multiple destinations, it may select different cargo vehicles from the managed set and assign each selected vehicle to a corresponding destination.

Accordingly, when the cargo vehicles assigned to each destination have loaded their respective baggage, the storage space determining unit (610) may receive baggage status information from each cargo vehicle terminal (100) installed in the respective vehicles via the network (400), and based on the received baggage status information for each piece of baggage, may determine the corresponding storage spaces from among the plurality of storage spaces.

In one embodiment, the estimated arrival time prediction unit (620) may calculate the estimated arrival time required for a cargo vehicle to reach the smart warehouse based on traffic conditions and travel distances along the expected routes between the smart warehouse and the destinations.

More specifically, the estimated arrival time prediction unit (620) may identify the expected routes and travel distances between the destination and the smart warehouse based on real-time location information acquired from the cargo vehicle terminal (100), and match the traffic condition data received from the traffic server (200) to the expected routes. Thus, the estimated arrival time required for the cargo vehicle to arrive at the smart warehouse can be calculated based on traffic conditions and travel distances along those routes.

However, the scope is not limited to this. The estimated arrival time prediction unit (620) may also calculate the travel distance between the current position of the cargo vehicle in transit and the coordinates of the smart warehouse, collect real-time traffic information from the traffic server (200) to assess current traffic conditions along the route, and adjust the estimated travel time by considering factors such as traffic congestion, accidents, roadwork, and weather conditions, thereby calculating a final estimated arrival time.

At this time, the estimated travel time may be a result calculated in consideration of the average vehicle speed under normal road conditions. As such, the final estimated arrival time may be calculated based on information such as traffic congestion, accidents, road construction, weather conditions, average vehicle speed, and travel distance.

Furthermore, in one embodiment, the estimated arrival time prediction unit (620) may calculate the estimated arrival time required for each cargo vehicle to arrive at the smart warehouse based on traffic conditions and travel distances along the expected routes between the smart warehouse and each respective destination.

In this case, the estimated arrival time prediction unit (620) may determine whether the estimated arrival times of the cargo vehicles carrying each piece of baggage fall within a predetermined time range. For example, if the estimated arrival time of cargo vehicle A is 100 minutes, cargo vehicle B is 90 minutes, and cargo vehicle C is 80 minutes, then the time interval between their arrivals, which is up to 20 minutes, may be considered to fall within the predetermined time range.

The reason for defining this predetermined time range as a very short time frame is to enable efficient relocation of obstructing baggage storage units along the baggage movement route within the short dispatch window, thereby allowing the multiple pieces of baggage to be placed in their designated storage spaces quickly and without confusion.

However, if the arrival time gaps between the cargo vehicles A, B, and C are long, it may indicate that there is sufficient time to place each piece of baggage into its respective storage space. Therefore, such long time gaps are not considered to fall within the predetermined time range.

In one embodiment, the pre-setting unit (630) may, before the cargo vehicle arrives at the entrance of the smart warehouse that is, within the estimated arrival time, relocate baggage from at least one storage space (375) located along the baggage movement route (370) to another storage space, in order to pre-secure the baggage movement route (370) from among multiple storage spaces for loading baggage from the vehicle. This process of securing the baggage movement route in advance is referred to as “pre-setting.”

For example, if the estimated arrival time is 100 minutes, the pre-setting unit (630) may, before placing the baggage from the cargo vehicle into the predetermined storage space (380) via the in/out section (360), relocate baggage from at least one storage space (375) located along the baggage movement route (370) between the predetermined storage space (380) and the in/out section (360), so that there are no obstacles (e.g., baggage storage units already placed in that space).

At this time, although what is actually being moved is not the baggage itself but the baggage storage unit (350) carrying the baggage, for the sake of convenience, it is expressed as if the baggage is being moved to another storage space (385).

In this case, if vertical movement is required for transporting the baggage to the determined storage space, elevator movement may be included in the pre-setting process. That is, the pre-setting unit (630) may pre-set the elevator movement in advance when moving the baggage to a predetermined storage space (380) located on a different floor, rather than among the multiple storage spaces (340) on the first floor.

By pre-setting the elevator movement in this way, it will be possible to immediately unload baggage from the vehicle arriving around the estimated arrival time, directly place it into the baggage storage unit equipped in the elevator, and then move it to the predetermined storage space.

Meanwhile, such a pre-setting unit (630) may determine the initiation time of the pre-setting based on the time information required to move other baggage in order to secure the baggage movement route.

At this time, the initiation time of the pre-setting refers to the point in time when necessary operations begin before the baggage movement starts, and it means completing all required preparations in advance so that the baggage movement can be smoothly carried out by the target time.

For example, in order to move a certain baggage, other baggage with a higher priority may need to be moved first. By calculating based on the time information when such movement should begin and preparing in advance, it is possible to move the obstructing baggage storage unit (baggage) located on the movement route to another storage space with sufficient time before the target time (i.e., the time indicated in the time information).

Furthermore, the pre-setting unit (630) according to one embodiment may perform pre-setting to secure the baggage movement route in advance for loading baggage from the cargo vehicle within each estimated arrival time, by moving baggage from at least one storage space located along the baggage movement route to another storage space.

Here, in the configuration of multiple baggage movement routes, the pre-setting unit (630), when the estimated arrival times of the cargo vehicles carrying respective baggage are calculated to fall within a certain time range by the arrival time prediction unit (620), may set a baggage movement route (390) as shown in FIG. 8. This route may define a loading area in the smart warehouse (e.g., a storage space adjacent to the loading/unloading section) as the departure point (391), the storage space for the baggage carried by the earliest arriving vehicle as the destination (392), and the storage spaces for baggage on vehicles arriving later as waypoints (393).

For example, if the baggage on the C vehicle, which has an estimated arrival time of 80 minutes, is to be placed in a pre-designated storage space (392), the pre-setting unit (630) may set that particular storage space (392) as the destination for the fastest-arriving C vehicle. Then, if baggage on the subsequently arriving B vehicle is to be placed in a different storage space (393), that space may be set as a waypoint (393).

By setting the storage space of the baggage from the earliest-arriving vehicle as the destination (392), and setting the storage space of later arrivals as waypoints (393), all baggage storage units located along the movement route, covering both the waypoint and destination, can be moved in advance to other storage spaces. This ensures that a clear, obstacle-free route is secured beforehand, preventing the need for multiple rounds of obstacle removal. As a result, the time required to move obstacles is reduced, ultimately shortening the pre-setting time.

In addition, the pre-setting unit (630), when there are three or more destinations and three or more cargo vehicles loaded with baggage for those destinations, may set a single baggage movement route for the three pieces of baggage.

In this case, as shown in FIG. 8, the pre-setting unit (630) may set multiple waypoints in the baggage movement route. For example, based on the estimated arrival times of the cargo vehicles, it may set a designated storage space (392) as the destination for the earliest-arriving vehicle (C vehicle), the storage space (393) for the second-arriving vehicle (B vehicle) adjacent to the destination (392) on the route, and the storage space (394) for the last-arriving vehicle (A vehicle) adjacent to the departure point (391) as another waypoint (394).

By setting multiple waypoints between the departure point and the destination for multiple pieces of baggage, a unified baggage movement route including the departure point, multiple waypoints, and the destination can be secured. This enables the pre-movement of baggage storage units located between the departure and destination points, allowing immediate placement of each piece of baggage as soon as the vehicles arrive, even for the first-arriving vehicle, since the route has already been secured in advance.

In one embodiment, the smart warehouse selection unit (640), while managing the storage of baggage in multiple smart warehouses, may select which smart warehouse will store the baggage from the destination after receiving a baggage transport request from the cargo vehicle terminal (100) installed in the vehicle that has loaded the baggage at the destination.

In this case, the smart warehouse selection unit (640) may select a specialized smart warehouse, among the plurality of smart warehouses, that corresponds to the nature of the baggage loaded in the cargo vehicle.

Here, each of the plurality of smart warehouses may be a location specialized for storing a specific type of baggage. For example, one smart warehouse may store only baggage sensitive to humidity, while another may store only baggage sensitive to temperature. Accordingly, the selected smart warehouse would be one of such specialized warehouses.

In such cases, the smart warehouse selection unit (640) may select a specialized smart warehouse that matches the nature of the baggage, for example, based on baggage status information acquired from the cargo vehicle terminal (100).

As described above, the functional operations of the respective components according to various embodiments may be implemented in the form of program instructions recorded on computer-readable recording media and/or memory.

The aforementioned computer-readable recording medium may include, either alone or in combination, program instructions, data files, and data structures. The program instructions recorded on the computer-readable recording medium may be specially designed and configured for the present invention or may be known and available to those skilled in the field of computer software. Examples of computer-readable recording media include magnetic media such as hard disks, floppy disks, and magnetic tapes; optical recording media such as CD-ROMs and DVDs; magneto-optical media such as floptical disks; and hardware devices such as ROM, RAM, and flash memory that are specially configured to store and execute program instructions. Examples of program instructions include machine language code, such as that generated by a compiler, and high-level language code that can be executed by a computer using an interpreter or the like. Such hardware devices may be configured to operate as one or more software modules for performing the processes of the present invention, and vice versa.

Therefore, although the specific matters such as the detailed components according to various embodiments of the present disclosure have been described above with reference to exemplary embodiments and drawings, they are provided only to aid general understanding and are not intended to limit the scope of various embodiments. Those skilled in the art to which the present invention pertains will appreciate that various modifications and variations are possible from the foregoing disclosure.

Accordingly, the spirit of the present invention should not be construed as being limited to the above-described embodiments, and all modifications and equivalents of the claims set forth below should be considered to fall within the scope of the spirit of the present invention.

What is claimed is:

1. A method for scheduling baggage loading in a smart warehouse, performed by a smart warehouse terminal apparatus, the method comprising:
determining a storage space in the smart warehouse for storing a baggage based on baggage status information of the baggage loaded onto a cargo vehicle upon completion of loading the baggage onto the cargo vehicle at a destination;
calculating an estimated arrival time at which the cargo vehicle is expected to arrive at the smart warehouse based on traffic status information between the smart warehouse and the destination; and
initiating a pre-setting process at a required point in time within the estimated arrival time to load the baggage from the cargo vehicle into the determined storage space in the smart warehouse.

2. The method of claim 1, wherein
the smart warehouse comprises a plurality of storage spaces arranged in a matrix structure, and at least one storage space corresponding to the amount of the baggage loaded on the cargo vehicle is determined from among the plurality of storage spaces.

3. The method of claim 1, wherein
the baggage status information comprises at least one of a weight, volume, height, temperature, humidity, and smell of the baggage.

4. The method of claim 1, wherein
If floor-to-floor transfer is required to move the loaded baggage to the determined storage space, a movement of an elevator is included in the pre-setting process.

5. The method of claim 1, wherein
the required point in time is determined, in order to secure a baggage movement path to the determined storage space in the smart warehouse, based on time information required to move other baggage positioned along the baggage movement path.

6. The method of claim 1, further comprising:
assigning different cargo vehicles respectively to each of a plurality of destinations upon receiving requests for baggage transport from the plurality of destinations.

7. The method of claim 6, wherein
the initiating of the pre-setting process is characterized in that, based on the baggage status information of the baggage loaded at each of the respective destinations, storage spaces for respective baggage are determined, and when the estimated arrival times of the cargo vehicles carrying the respective baggage are calculated to fall within a certain time range, a baggage movement path is configured such that the storage space for the baggage loaded on the cargo vehicle expected to arrive first at the smart warehouse is set as a final destination and the storage space of baggage loaded on subsequently arriving cargo vehicles is set as waypoints.

8. The method of claim 7, wherein
the initiating of the pre-setting process is characterized in that when the number of destinations is three or more, a plurality of waypoints is set in the baggage movement path, and the storage space for the baggage expected to arrive earlier is arranged closer to the final destination along the baggage movement path, based on the estimated arrival times of the cargo vehicles carrying the respective baggage.

9. The method of claim 1, further comprising:
selecting a smart warehouse in which the baggage is to be stored among a plurality of smart warehouses, based on baggage status information of the baggage loaded in the cargo vehicle at the destination.

10. A smart warehouse terminal apparatus for scheduling baggage loading in a smart warehouse, comprising:
a memory configured to store at least one program instruction; and
a processor,
wherein the at least one program instruction, when executed by the processor, causes the processor to:
determine a storage space in the smart warehouse for storing a baggage based on baggage status information of the baggage loaded onto a cargo vehicle upon completion of loading the baggage onto the cargo vehicle at a destination;
calculate an estimated arrival time at which the cargo vehicle is expected to arrive at the smart warehouse based on traffic status information between the smart warehouse and the destination; and
initiate a pre-setting process at a required point in time within the estimated arrival time to load the baggage from the cargo vehicle into the determined storage space in the smart warehouse.
